(19) United States
(12) Patent Application Publication
(10) Pub. No.: US 2014/0251279 A1
(43) Pub. Date: Sep. 11, 2014

(54) CONTROL OF THE INJECTION OF FUEL UPON COMBUSTION ENGINE START-UP

(71) Applicant: RENAULT s.a.s., Boulogne-Billancourt (FR)

(72) Inventors: Sylvain Hourlier, Arpajon (FR); Patrick Perennes, Lisses (FR); Franck Breuille-Martin, Intville-La-Guetard (FR)

(73) Assignee: RENAULT s.a.s., Boulogne-Billancourt (FR)

(21) Appl. No.: 14/347,462

(22) PCT Filed: Sep. 25, 2012
(86) PCT No.: PCT/FR12/52134

§ 371 Date: Mar. 26, 2014

(30) Foreign Application Priority Data
Sep. 26, 2011 (FR) 11 58564

(51) Int. Cl. F02D 41/30

(52) U.S. Cl. CPC F02D 41/30
USPC 123/478

(57) ABSTRACT

A method for controlling injection of fuel upon start-up of a combustion engine including determining a set point quantity of fuel on start up, which is dependent on a difference between a set point acceleration of the engine and an instantaneous acceleration of the engine. An electronic control unit and a motor vehicle can execute the method.

### TECHNICAL FIELD OF THE INVENTION

The invention relates to the field of controlling the injection of fuel, notably of petrol, on starting up a heat engine, used in particular in the context of a motor vehicle.

More particularly, the subject of the invention is a method for controlling the injection of fuel on starting up a heat engine, an electronic control unit implementing this method, and a motor vehicle equipped with such a unit.

### STATE OF THE ART

The increasing research into reducing polluting emissions is leading to a search for consumption savings on heat engines and therefore to optimizing to the maximum all the areas of operation of the engine.

The engine start-up phase is a generator of consumption and of polluting emissions because, during this phase, a high energy has to be supplied to start the engine. This problem is all the more critical as the exhaust gas post-treatment system at the same time exhibits a low efficiency because of its low heat balance. Any fuel not consumed by the explosions in the engine is present in the form of HC/CO in the exhaust.

As is known, the control of the injection during the start-up phase of an internal combustion engine makes use of an open loop automation solution and therefore demands a calibration that takes into account the variances associated with manufacture, environment, and fuel type, which affect the engine. The injection is regulated (by controlling the opening/closing of the injectors to adjust the injection time) on a flat rate setpoint which takes into account these variances to increase the richness of the air/fuel mixture. The air/fuel mixture has to be strongly enriched on start-up for this operation to be possible regardless of the conditions. In particular, the calibration must make it possible to start the engine at its most inert (i.e. exhibiting the greatest internal mechanical frictions) fed by fuel with the lowest possible volatility. The result of this, in most cases, is an excessive consumption compared to the real needs of each engine and polluting emissions that are not treated by the post-treatment system which generally includes a catalyst and which has not yet reached its operating temperature on start-up.

Only after a sufficient temperature has been reached following start-up does a control by closed loop automation become possible. In practice, before reaching this temperature, the determination of a reliable signal representative of the richness in order to allow for a necessary return to closed loop regulation remains currently impossible.

### OBJECT OF THE INVENTION

The aim of the present invention is to propose a solution for controlling the injection of fuel on starting up a heat engine which remedies the drawbacks listed above.

A first aspect of the invention relates to a method for controlling the injection of fuel on starting up a heat engine, which comprises a first step of determining a setpoint fuel quantity on start-up, as a function of a difference between a setpoint acceleration of the engine and an instantaneous acceleration of the engine.

The determination step can comprise a first phase of determining a difference between a real engine speed derivative and an engine speed derivative setpoint, the difference between the real speed derivative and the speed derivative setpoint being representative of the difference between the setpoint acceleration of the engine and the instantaneous acceleration of the engine.

In the first phase, the real speed derivative can be determined from a value of the instantaneous speed derivative of the engine of a temperature of an engine cooling heat-transfer liquid.

In the first phase, the engine speed derivative setpoint can be determined from the temperature of the engine cooling heat-transfer liquid, the computation pitch of said derivative being proportional to the instantaneous speed.

The determination step can comprise a second phase of generation of a richness correction factor on start-up, from a mapping which takes as input the difference between the real speed derivative and the engine speed derivative setpoint and the temperature of the engine cooling heat-transfer liquid.

The mapping can correspond to a richness correction proportional regulator.

The determination step can comprise a third phase of characterizing the setpoint fuel quantity on start-up, from the richness correction factor on start-up and from a pre-established basic setpoint fuel quantity.

The characterization third phase can comprise a modulation of the richness correction factor on start-up as a function of the possible number of engine restarts.

The method can comprise a second step consisting in injecting a quantity of fuel corresponding selectively to the setpoint fuel quantity on start-up determined in the first step or a pre-established basic setpoint fuel quantity.

The selection from the setpoint fuel quantity on start-up and the pre-established basic setpoint fuel quantity depends at least on a first condition exploiting a criterion associated with the instantaneous speed of the engine and a second condition exploiting a criterion associated with the difference between a real speed derivative of the engine and an engine speed derivative setpoint.

The first condition can be satisfied, for example, if the instantaneous speed of the engine is greater than or equal to a predetermined first threshold.

The second condition can be satisfied, for example, if the difference between the real speed derivative of the engine and the engine speed derivative setpoint is greater than or equal to a predetermined second threshold.

The second step can consist in injecting, for a determined duration, the setpoint fuel quantity on start-up determined in the first step, when the first and second conditions are simultaneously satisfied.

The determined duration can be a function of the temperature of the engine cooling heat-transfer liquid.

The selection from the setpoint fuel quantity on start-up and the pre-established basic setpoint fuel quantity can depend on the possible number of engine restarts.

The second step can comprise a regulation of the fuel injection time on the engine as a function of the quantity of fuel to be injected.

A second aspect of the invention relates to an electronic control unit which implements the method for controlling the injection of fuel on starting up a heat engine as presented above.

A third aspect of the invention relates to a motor vehicle comprising such an electronic control unit, a heat engine, and a fuel injection device supplying the heat engine and driven by the electronic control unit.

### BRIEF DESCRIPTION OF THE DRAWINGS

Other advantages and features will emerge more clearly from the following description of particular embodiments of the invention, given as nonlimiting examples and represented in the appended drawings, in which:

FIG. 1 illustrates the block diagram of an exemplary electronic control unit implementing a control method according to the invention,

FIG. 2 illustrates the structure of the “Startup_Factor” block of FIG. 1,

FIG. 3 illustrates the structure of the “Setpoint_Derivative” block of FIG. 2,

FIG. 4 illustrates the structure of the “Instantaneous derivative” block of FIG. 2,

FIG. 5 illustrates the structure of the “Startup_Fuel_Weight” block of FIG. 1,

FIG. 6 illustrates the structure of the “Startup_Mode” block of FIG. 5,

FIG. 7 illustrates the structure of the “Fuel_Weight_Application” block of FIG. 5,

FIG. 8 illustrates the structure of the “Deactivation_Condition” block of FIG. 7,

and FIG. 9 represents the trend curve in time of the engine speed and of the difference between a setpoint acceleration of the engine and an instantaneous acceleration of the engine, when the control according to the invention is applied.

### DESCRIPTION OF PREFERENTIAL EMBODIMENTS OF THE INVENTION

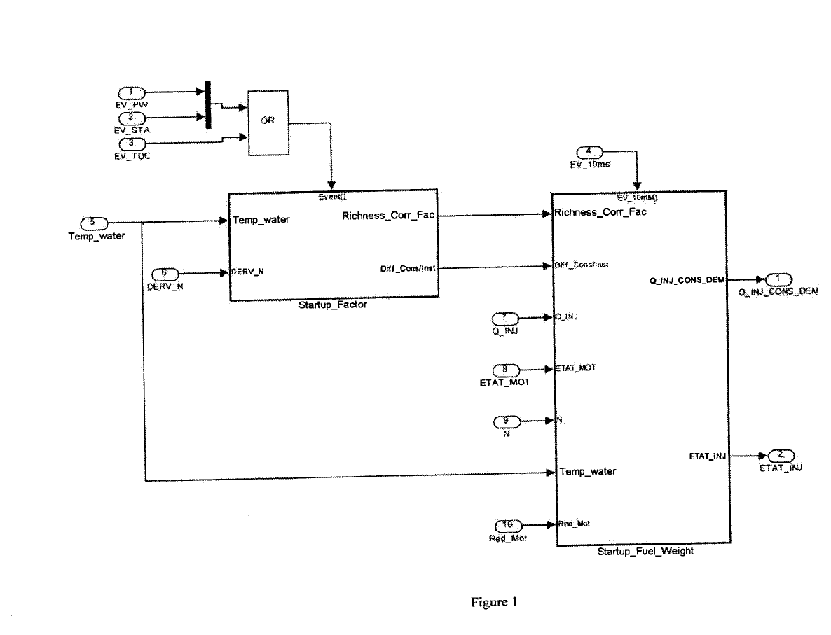

The solution proposed below, with reference to FIGS. 1 to 9, relates to the control of the injection of a fuel, for example of petrol, during the operation of starting up a heat engine, for example installed in a vehicle, notably of motor vehicle type.

A first aspect thus relates to a method for controlling the injection of fuel on starting up a heat engine. According to an important feature, the method comprises a first step consisting in determining a setpoint fuel quantity on start-up, the determination being a function of a difference between a setpoint acceleration of the engine and an instantaneous acceleration of the engine. As will also be detailed below, the control method then comprises a second step consisting in injecting a quantity of the fuel “Q_INJ_CONS_DEM” corresponding selectively either to the setpoint fuel quantity on start-up “Q_INJ_DEM” determined in the first step, or to a pre-established basic setpoint fuel quantity “Q_INJ”.

The principle of this control is therefore to compare an acceleration setpoint of the engine and the real acceleration of the engine. It particularly concerns the angular acceleration. The difference thus obtained is representative of the mechanical torque delivered by the engine and necessary to the start-up.

FIG. 1 illustrates the block diagram of an exemplary electronic control unit implementing a control method according to the invention. For this, the control unit comprises a first block for establishing a richness correction factor on start-up, this first block being called “Startup_Factor”. This correction factor “Richness_Corr_Fac” output from the first block “Startup_Factor” supplies one of the inputs of a second block establishing the quantity of fuel to be injected “Q_INJ_CONS_DEM”, this block being called “Startup_Fuel_Weight” in FIG. 1.

Hereinbelow, the rest of the nomenclature between the drawings and the terms of the description is as follows:
temperature of an engine cooling heat-transfer liquid: “Temp_water”,
instantaneous engine speed derivative: “DERV_N”,
engine states: “ETAT_MOT”,
real engine speed: “N”,
pre-established basic setpoint fuel quantity: “Q_INJ”,
events on the powering up of the unit: “EV_PW”,
events on the stalling of the engine: “EV_STA”,
events on the top-dead-center points: “EV_TDC”,
periodic event, for example with a period of 10 ms, allowing for the discrete mode computation of the first step in order to be able to be integrated in an engine computer: “EV_{—}10 ms”.

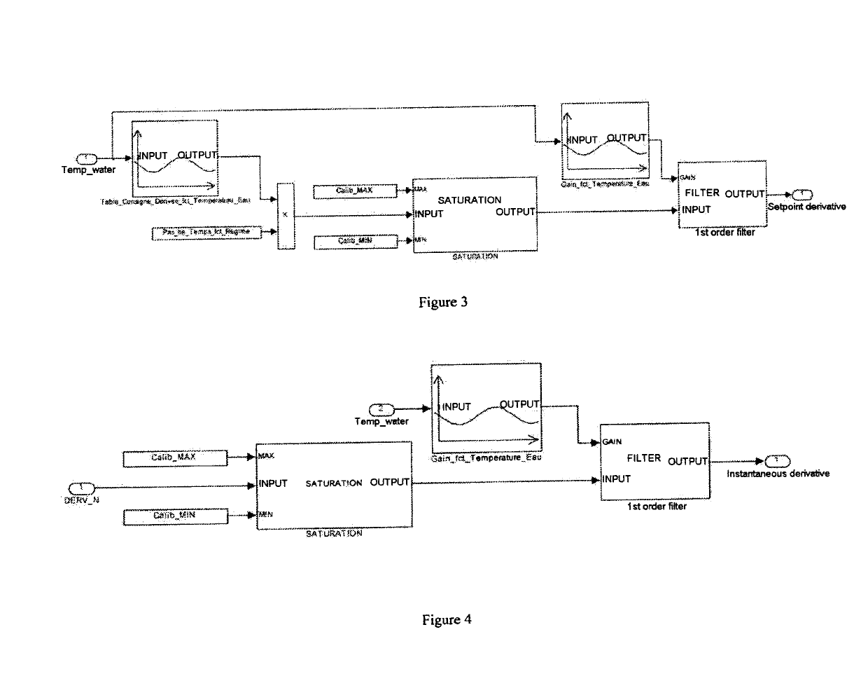

To be able to compare the acceleration setpoint of the engine and the real acceleration of the engine, the determination step comprises a first phase of determining a difference between a real speed derivative of the engine (output 1 called “Instantaneous derivative” in FIG. 4) and an engine speed derivative setpoint (output 1 called “Setpoint derivative” in FIG. 3), the difference between the real speed derivative and the speed derivative setpoint being representative of the difference between the setpoint acceleration of the engine and the instantaneous acceleration of the engine.

The reasoning is as follows:

The following is posited:

$$E = \frac{1}{2} I {ω}^{2} et P = C ω et \frac{d E}{d t} = P$$

With

E: the energy

I: the moment of inertia

ω: the engine speed

P: the power

C: the torque

For the derivative setpoint, the following is deduced:

$$\frac{d {E}_{sp}}{d t} = {C}_{sp} {ω}_{sp} ⇒ \frac{{E}_{sp} - {E}_{sp ( i - 1 )}}{dt} {C}_{sp} {ω}_{sp}$$

For the rest of the reasoning, the moment of inertia and the constant, identical to the two accelerations of energies, are disregarded.

$$\frac{{E}_{sp} - {E}_{sp ( i - 1 )}}{{ω}_{sp} \times dt} = {C}_{sp} = \frac{{ω}_{sp}^{2} - {ω}_{sp ( i - 1 )}^{2}}{{ω}_{sp} \times d t}$$

ωsp being a function of “dt”, the transition to discrete mode gives

$$\frac{{ω}_{sp} - {ω}_{sp ( i - 1 )}}{d t} = \frac{d {ω}_{sp}}{d t} = {C}_{sp}$$

With an identical reasoning for the instantaneous torque, the following applies

$${C}_{i} = \frac{d {ω}_{i}}{d t}$$

The difference between the two derivatives (setpoint and instantaneous) gives an image of the torque needed to reach the setpoint as a function of the instantaneous speed.

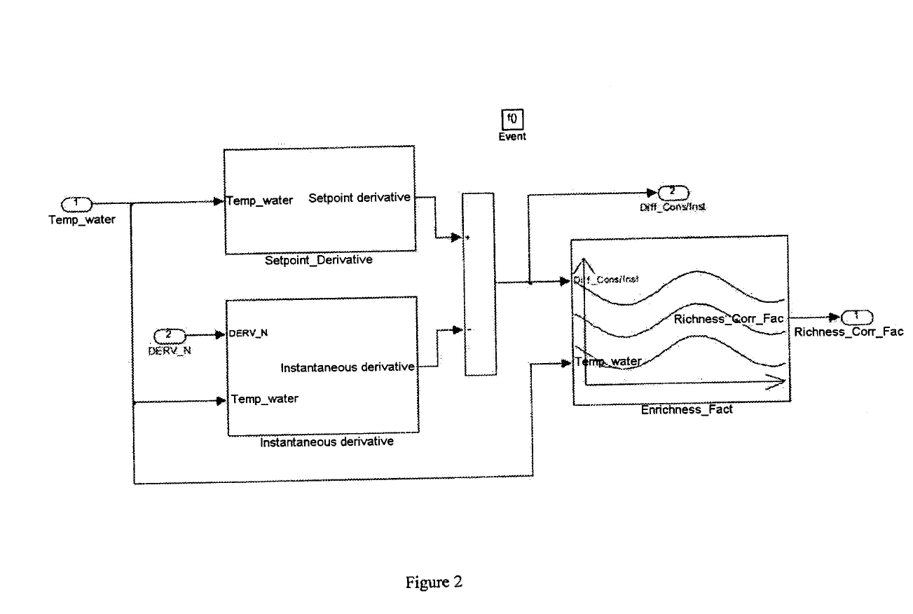

Thus, FIG. 2 illustrates the structure of the “Startup_Factor” block of FIG. 1, which is made up, on the one hand, of a “Setpoint_Derivative” block detailed in FIG. 3 and, on the other hand, of an “Instantaneous derivative” block detailed in FIG. 4. The “Instantaneous derivative” block determines the real speed derivative of the engine, corresponding to the output signal 1 called “Instantaneous derivative” in FIG. 4. The “Setpoint derivative” block determines the engine speed derivative setpoint, corresponding to the output signal 1 called “Setpoint derivative” in FIG. 3.

In the first phase, and with reference to FIG. 4, the real speed derivative (output 1 called “Filtered speed derivative” in FIG. 4) is determined from a value of the instantaneous speed derivative of the engine (input called “DERV_N”) and a temperature of an engine cooling heat-transfer liquid (input called “Temp_water”).

The setpoint derivative is constructed in the form:

$$N\_grd = \frac{N \cdot ( N - {N}_{i - 1} )}{120} \times {N}_{cyi}$$

which is not represented. This computation is performed at the TDC (via the “EV_TDC” parameter) in order to be consistent with the computation of the engine speed derivative setpoint (output 1 called “Setpoint derivative” in FIG. 3).

A first order filter “1st order filter” of type

DervN_{filtered}=k·DervN_{raw}+(1−k)·DervN_{filtered-1}

makes it possible to filter the derivative in order to eliminate the noise. The factor “k” depends on “Temp_water” using the block “Gain_fct_Temperature_Water”. A saturation “Saturation” between a maximum value and a minimum value also makes it possible to avoid excessive swings in the derivative.

Also in the first phase and with reference to FIG. 3, the engine speed derivative setpoint (output 1 called “Setpoint derivative” in FIG. 3) is determined from the temperature of the engine cooling heat-transfer liquid (“Temp_water”). The computation pitch of said derivative is proportional to the instantaneous speed “N” by virtue, for example, of the input “Event( )” of the “Startup_Factor” block in FIG. 1.

More specifically, the “Setpoint_Derivative” structure computes the derivative at each top dead center point “EV_TDC” and on initializations on power up “EV_PW” and on engine stalling “EV_STA”. Thus, the computation is consistent with the computation of the filtered speed derivative in relation to FIG. 4. The speed setpoint, also called setpoint derivative, is a function of the computation pitch, the latter being a function of the speed “N”. There is then an image of the power needed on startup. The operation thus obtained is a derivative mode setpoint “Setpoint derivative” which varies as a function of the instantaneous speed “N” and tends to decrease as the speed increases. A saturation “Saturation” as well as a first order filter allow for consistency with respect to the computation of the filtered speed derivative in relation to FIG. 4. This filter is of the type

DervN_{filtered}=k·DervN_{raw}+(1−k)·DervN_{filtered-1}

and makes it possible to eliminate the noise. The factor “k” depends on “Temp_water” by virtue of the “Gain_{—} fct_Temperature_Water” block in FIG. 3.

The determination step comprises a second phase of generation of the richness correction factor on start-up “Richness_Corr_Fac”, from a mapping (“Enrichness_Fact” block in FIG. 2) taking as input “VAR_X” the difference between the real speed derivative and the engine speed derivative setpoint, and the temperature of the engine cooling heat-transfer liquid “TCO” at the input “VAR_Y”. Notably, the mapping corresponds to a richness correction proportional regulator.

In practice, since the difference between the acceleration setpoint of the engine and the real acceleration of the engine cannot be directly transposed for a heat engine, it becomes the input of a proportional correction on the richness. Thus, the correction made during the start-up is significant at low speeds and drops, even becomes negative, as the speed rises if the real angular acceleration of the heat engine exceeds the setpoint (which can be the case for an engine with very little inertia).

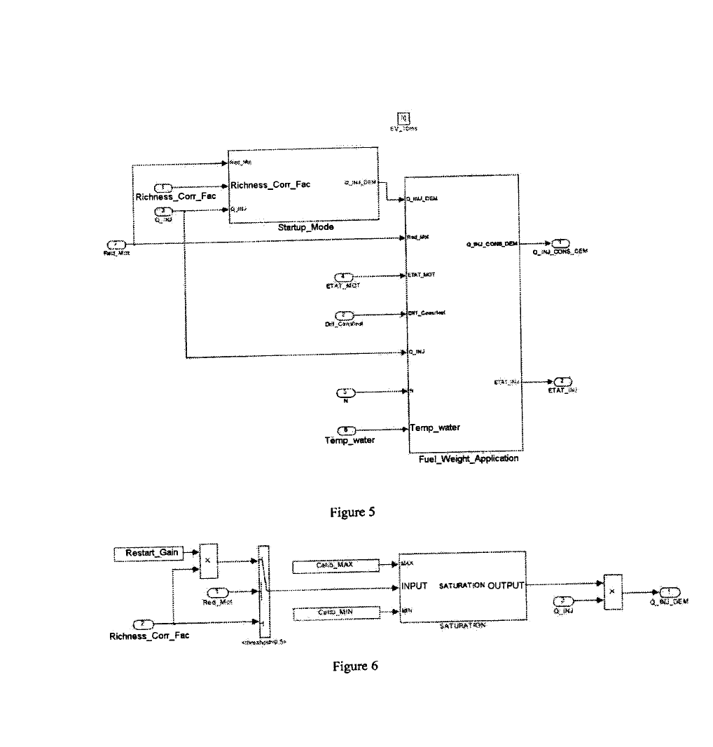

In addition, and with reference to FIG. 5, the determination step comprises a third phase of characterizing the setpoint fuel quantity on start-up “Q_INJ_DEM”, from the richness correction factor on start-up “Richness_Corr_Fac” and from a pre-established basic setpoint fuel quantity “QJNJ”. This characterization phase is performed periodically, for example from the event “EV_{—}10 ms”.

However, the quantity “QJNJ” is not directly multiplied by the gain “Richness_Corr_Fac” output from the “Startup_Factor” block and input to the “Startup_Fuel_Weight” block. On the contrary, the characterization third phase comprises a modulation of the richness correction factor on startup “Richness_Corr_Fac” as a function of the possible number of engine restarts. This modulation performed in the “Startup_Mode” block depends on the input “Red_Mot”; this variable is derived from a computation which is not represented.

The “Startup_Mode” block is detailed in FIG. 6. The “Red_Mot” parameter is used to apply a modulation to the “Richness_Corr_Fac” parameter in order to establish a final enrichment factor that takes into account a concept of difference of the moment of inertia and of the frictions on start-up between a first start-up situation and a restart situation. It is this final enrichment factor which is multiplied with the quantity “Q_INJ” to obtain the “Q_INJ_DEM” parameter.

In other words, the “Red_Mot” parameter makes it possible to detect possible successive start-ups. In practice, during a first start-up, the oil film is not established, provoking more significant frictions. This first start-up requires a higher torque, therefore a greater quantity of fuel. Corrections are applied via this detection for the restarts in the “Startup_Mode” and “Fuel_Weight_Application” blocks.

More specifically, the “Startup_Mode” block allows for a consolidation of the richness correction factor “Richness_Corr_Fac”. A gain makes it possible to correct this factor upon restarts, then the factor is limited by a saturation in order to avoid aberrant factors to be finally multiplied by the quantity “QJNJ”. The latter being computed from the estimation of the air flow rate entering into the engine and the stoichiometry as well as various corrections as required.

This control principle makes it possible to bring to the heat engine the precise quantity of fuel necessary for the start-up, by virtue of the time-variable modulation conferred by the richness correction factor on startup that is thus generated.

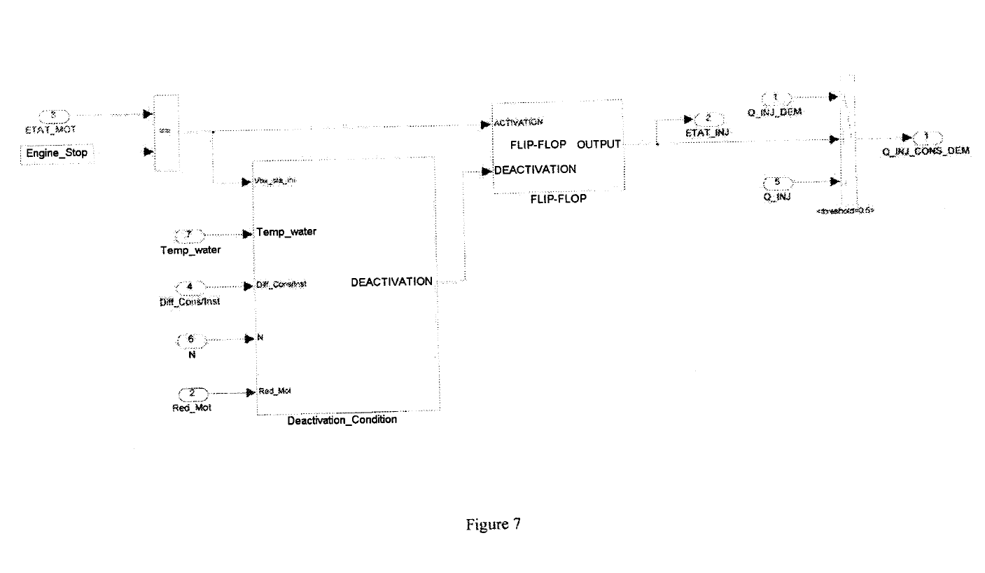

The control also comprises, as indicated previously and with reference to FIG. 7, a second step consisting in injecting a quantity of fuel “Q_INJ_CONS_DEM” corresponding selectively to the setpoint fuel quantity on start-up “Q_INJ_DEM” determined in the first step or the pre-established basic setpoint fuel quantity “Q_INJ”.

Notably, the method exploits the pre-established basic set-point fuel quantity “Q_INJ”. This quantity is exploited in a first start-up sequence in combination with the total enrichment factor. Then, once the first sequence is finished, the method provides a second post-startup sequence during which the fuel injection is controlled directly only from the pre-established basic setpoint fuel quantity “Q_INJ”, independently of the total enrichment factor.

From all of the above, it emerges that the control principle makes it possible to introduce a concept of regulation of the richness during start-up phases. The advantages are:
a best fit management of what is needed for the injection while retaining the start-up service (robustness, starting time, etc.),
an inclusion of the drifts and dispersions by virtue of this regulation which is, for example, proportional,
a more “physical” adjustment of the start-up operation (based on a setpoint richness).

The result thereof is a more accurate management of the quantities of fuel injected during the start-up phase. The consumption and the polluting emissions are reduced, also allowing for potential savings on the proportion of precious metals in the possible catalyst in post-treatment.

It should be noted that the proposed solution, although more “physical” and closer to the needs of the engine, remains a proportional regulation in open loop mode. The accuracy of the richness obtained in relation to the setpoint richness depends a lot on the basic set-up of the engine, notably the filling.

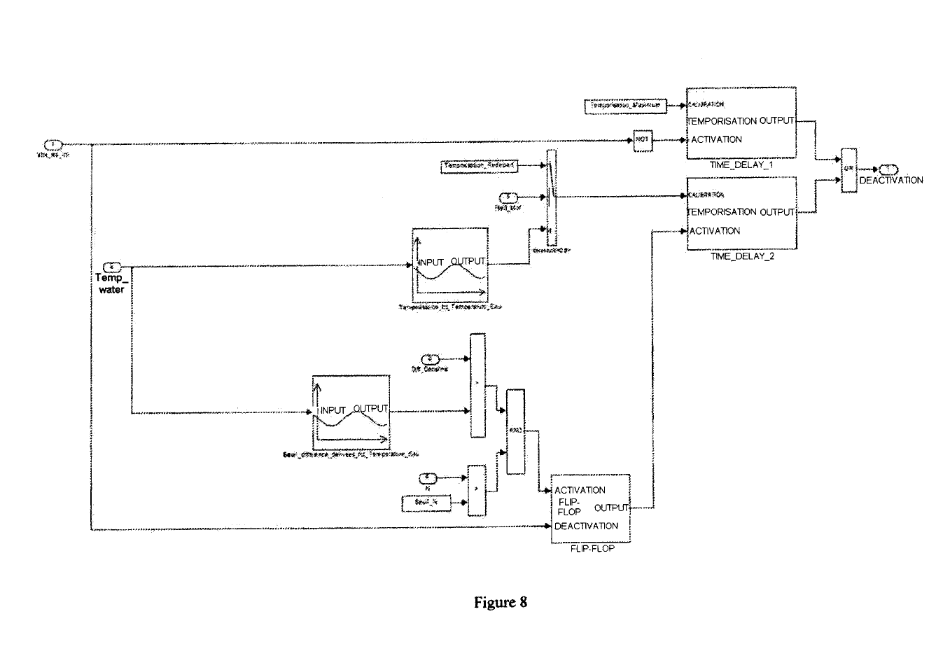

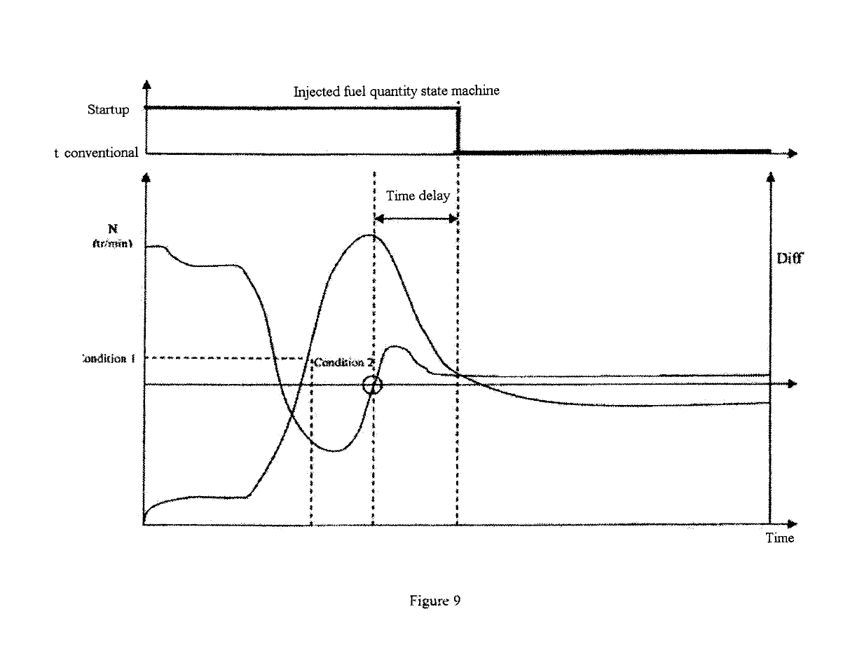

With reference to FIG. 8, the selection from the setpoint fuel quantity on start-up “Q_INJ_DEM” and the pre-established basic setpoint fuel quantity “Q_INJ” depends at least on a first condition exploiting a criterion associated with the instantaneous speed “N” of the engine and a second condition exploiting a criterion associated with the difference “Diff_Cons/Inst” (corresponding to the output referenced 2 in FIG. 2) between the filtered real speed derivative of the engine and the engine speed derivative setpoint. This selection is made periodically, for example from the event “EV_{—}10 ms”.

For example, the first condition is satisfied if the instantaneous speed “N” of the engine is greater than or equal to a predetermined first threshold, for example equal to 1000 rpm. So, the second condition is, for example, satisfied if the difference between the filtered real speed derivative of the engine and the engine speed derivative setpoint is greater than or equal to a predetermined second threshold, for example equal to 0.

The second step can notably consist in injecting, for a determined duration Δ (FIG. 9), the setpoint fuel quantity on start-up “Q_INJ_DEM” determined in the first step, when the first and second conditions are simultaneously satisfied. The determined duration is a function, for example, of the temperature of the engine cooling heat-transfer liquid “Temp_water” (input 7 of the “Reset_condition” block).

Furthermore, the selection from the setpoint fuel quantity on start-up “Q_INJ_DEM” and the pre-established basic setpoint fuel quantity “Q_INJ” depends on the possible number of engine restarts, through the signal “Red_Mot” and input (input 2) into the “Deactivation_Condition” block of FIG. 7, detailed in FIG. 8. It is also in order to satisfy the first and second conditions that the engine speed signal “N” (input 6) and the signal corresponding to the difference between the setpoint and instantaneous derivatives (input 4) are addressed as input for the “Deactivation_Condition” block.

For its implementation, the second step can notably comprise a regulation of the fuel injection time on the engine as a function of the quantity of fuel to be injected “Q_INJ_CONS_DEM”.

A second aspect of the invention relates to an electronic control unit which implements the method for controlling the injection of fuel on starting up a heat engine as developed above. The control unit comprises all the blocks described previously.

A third aspect of the invention relates to a motor vehicle comprising an electronic control unit as mentioned above, a heat engine, and a fuel injection device supplying the heat engine and driven by the electronic control unit.

The invention finally relates to a heat engine controlled by a control unit as described above, and a data storage medium that can be read by the control unit, on which is stored a computer program comprising computer program code means for implementing the phases and/or the steps of a control method as mentioned above.

Finally, it relates to a computer program comprising a computer program code means suitable for performing the phases and/or the steps of a control method as mentioned above, when the program is running on such a control unit.

In FIG. 9, the control unit (incorporated in any suitable computer or automaton) makes it possible to define (curve C1) a start-up state (injection of the quantity “Q_INJ_DEM”) to the left of the line T and a conventional operating state (injection of the quantity “Q_INJ”) to the right of the line T. The start-up (left-hand part of the curves C1 to C3 in relation to the line identified T) comprises the correction described previously in relation to the quantity “Q_INJ” by virtue of the total richness factor which is itself determined by virtue of the richness correction factor on start-up.

The curve C2 represents the trend over time of the engine speed “N”, and the illustration of the condition 1. The curve C3 illustrating the difference between the derivative setpoint and the real speed derivative, represents the acceleration or the energy necessary for the starting of the engine. This difference is converted into gain on the richness. In FIG. 9, the determined duration of application of the quantity “Q_INJ_DEM” is identified Δ and corresponds to a time-delay before it ends on application of the quantity “Q_INJ”.

The control device described in this document can be adapted to the air control of the engine (via the gas butterfly valve) or to the control of advance during start-ups by taking as a reference respectively a reference butterfly valve opening and a reference value of the advance instead of the richness 1.

1-18. (canceled)

19. A method for controlling injection of fuel on starting up a heat engine, the method comprising:
determining a setpoint fuel quantity on start-up, as a function of a difference between a setpoint acceleration of the engine and an instantaneous acceleration of the engine.

20. The method as claimed in claim 19, wherein the determining comprises a first phase determining a difference between a real engine speed derivative and an engine speed derivative setpoint, the difference between the real speed derivative and the speed derivative setpoint being representative of the difference between the setpoint acceleration of the engine and the instantaneous acceleration of the engine.

21. The method as claimed in claim 20, wherein, in the first phase, the real speed derivative is determined from a value of instantaneous speed derivative of the engine and of a temperature of an engine cooling heat-transfer liquid.

22. The method as claimed in claim 20, wherein, in the first phase, the engine speed derivative setpoint is determined from a temperature of an engine cooling heat-transfer liquid, a computation pitch of the derivative being proportional to instantaneous speed.

23. The method as claimed in claim 20, wherein the determining further comprises a second phase generating a richness correction factor on start-up, from a mapping which takes as an input the difference between the real speed derivative and the engine speed derivative setpoint and a temperature of an engine cooling heat-transfer liquid.

24. The method as claimed in claim 23, wherein the mapping corresponds to a richness correction proportional regulator.

25. The method as claimed in claim 23, wherein the determining comprises a third phase of characterizing the setpoint fuel quantity on start-up, from the richness correction factor on start-up and from a pre-established basic setpoint fuel quantity.

26. The method as claimed in claim 25, wherein the third phase comprises a modulation of the richness correction factor on start-up as a function of a possible number of engine restarts.

27. The method as claimed in claim 19, further comprising injecting a quantity of fuel corresponding selectively to the setpoint fuel quantity on start-up determined in the determining or a pre-established basic setpoint fuel quantity.

28. The method as claimed in claim 27, wherein selection from the setpoint fuel quantity on start-up and the pre-established basic setpoint fuel quantity depends at least on a first condition exploiting a criterion associated with an instantaneous speed of the engine and a second condition exploiting a criterion associated with the difference between a real speed derivative of the engine and an engine speed derivative setpoint.

29. The method as claimed in claim 28, wherein the first condition is satisfied if the instantaneous speed of the engine is greater than or equal to a predetermined first threshold.

30. The method as claimed in claim 28, wherein the second condition is satisfied if the difference between the real speed derivative of the engine and the engine speed derivative setpoint is greater than or equal to a predetermined second threshold.

31. The method as claimed in claim 28, wherein the injecting includes, for a determined duration, injecting the setpoint fuel quantity on start-up determined in the determining, when the first and second conditions are simultaneously satisfied.

32. The method as claimed in claim 31, wherein the determined duration is a function of a temperature of an engine cooling heat-transfer liquid.

33. The method as claimed in claim 27, wherein selection from the setpoint fuel quantity on start-up and the pre-established basic setpoint fuel quantity depends on a possible number of engine restarts.

34. The method as claimed in claim 27, wherein the injecting includes a regulation of a fuel injection time on the engine as a function of a quantity of fuel to be injected.

35. An electronic control unit which implements the method for controlling the injection of fuel on starting up a heat engine as claimed in claim 19.

36. A motor vehicle comprising an electronic control unit as claimed in claim 35, a heat engine, and a fuel injection device supplying the heat engine and driven by the electronic control unit.
